(19) United States
(12) Patent Application Publication
(10) Pub. No.: US 2025/0303576 A1
(43) Pub. Date: Oct. 2, 2025

(54) CONTROL DEVICE FOR ROBOT DEVICE THAT ACQUIRES THREE-DIMENSIONAL POSITION INFORMATION, AND ROBOT DEVICE

(71) Applicant: FANUC CORPORATION, Yamanashi (JP)

(72) Inventor: Junichirou YOSHIDA, Yamanashi (JP)

(21) Appl. No.: 18/863,331

(22) PCT Filed: Jun. 6, 2022
(86) PCT No.: PCT/JP2022/022821

§ 371 Date: Nov. 6, 2024

(51) Int. Cl. B25J 9/16; B25J 13/08; B25J 19/02

(52) U.S. Cl. CPC B25J 9/1697; B25J 9/1674; B25J 13/089; B25J 19/023

(57) ABSTRACT

This control device for a robot device comprises: an imaging control unit that changes exposure conditions of a two-dimensional camera; and a position information generation unit that generates three-dimensional position information of an object on the basis of a two-dimensional image captured by the two-dimensional camera. The control device further comprises a synthesis unit that synthesizes a plurality of pieces of three-dimensional position information. While the robot is operating, the imaging control unit captures two-dimensional images at predetermined intervals under predetermined exposure conditions. When the robot stops, the imaging control unit changes the exposure conditions and captures a plurality of two-dimensional images, and the synthesis unit synthesizes a plurality of pieces of three-dimensional position information.

### RELATED APPLICATIONS

The present application is a National Phase of International Application No. PCT/JP2022/022821 filed Jun. 6, 2022.

### TECHNICAL FIELD

The present invention relates to a controller for a robot device that acquires three-dimensional position information, and a robot device.

### BACKGROUND ART

In the related art, there is known a vision sensor that images an object and detects three-dimensional position information of a surface of the object (e.g., Japanese Unexamined Patent Publication No. 63-251192 A). As such a vision sensor that detects a three-dimensional position, a two-dimensional camera can be adopted. For example, a stereo camera that detects three-dimensional position information of an object by parallax between two two-dimensional cameras, or a vision sensor that detects a three-dimensional position of an object by a phase shift method is known.

In recent years, there has become known a device that calculates, based on a three-dimensional position of a workpiece acquired by a vision sensor, a positional deviation of the workpiece when a robot grips the workpiece with a hand or a positional deviation of the workpiece fixed to a platform. The vision sensor can be attached to, for example, a distal end of an arm of the robot (e.g., Japanese Unexamined Patent Publication No. 2020-38074 A).

When the vision sensor is attached to the robot, an image can be captured by the vision sensor while the robot is driven. By capturing an image while the robot is driven, it is possible to quickly capture an image of an object from various directions. For example, when a simulation of a robot device is performed, it may be desirable to acquire three-dimensional position information of a peripheral object such as a device, a stand, or a shelf around the robot in advance. When acquiring the three-dimensional position information of the peripheral object, it is possible to capture an image while driving the robot.

Incidentally, a feature portion such as a contour line of the object may not be accurately, due to the intensity of light, the direction of light, the shape of the surface of the object, and the like. For example, halation or black crushing may occur in a two-dimensional image. In such a case, it is known to synthesize a plurality of images and thereby obtain an image having a large dynamic range (e.g., Japanese Unexamined Patent Publication No. 2002-334326 A).

### CITATION LIST

### Patent Literature

PTL 1: Japanese Unexamined Patent Publication No. 63-251192 A

PTL 2: Japanese Unexamined Patent Publication No. 2020-38074 A

PTL 3: Japanese Unexamined Patent Publication No. 2002-334326 A

### SUMMARY OF INVENTION

### Technical Problem

When an image is captured by a two-dimensional camera of a vision sensor while driving a robot, if halation or black crushing occur in the two-dimensional image, the three-dimensional position information of the object cannot be accurately acquired. An operator can adjust an exposure condition of the two-dimensional camera by stopping the robot each time the robot is slightly moved. Alternatively, a plurality of exposure conditions may be set in advance, and imaging may be repeated under the plurality of exposure conditions each time the robot is slightly moved. However, in these methods, it is necessary to stop the robot every time an image is captured, resulting in the problem that a significant amount of time is required for the work.

### Solution to Problem

A controller for a robot device of an aspect of the present disclosure includes a robot and a three-dimensional vision sensor including a two-dimensional camera configured to capture an image of an object. The controller includes an operation detecting unit configured to detect an operation state of the robot, and an imaging control unit configured to change an exposure condition of the two-dimensional camera. The controller includes a position information generating unit configured to generate three-dimensional position information of the object based on a two-dimensional image captured by the two-dimensional camera. The controller includes a synthesis unit configured to implement control for synthesizing a plurality of the two-dimensional images or control for synthesizing a plurality of pieces of the three-dimensional position information. During a period in which the operation detecting unit detects an operation of the robot, the imaging control unit captures the two-dimensional image at a predetermined interval under a predetermined exposure condition. When the operation detecting unit detects stopping of the robot, the imaging control unit changes the exposure condition and captures the plurality of two-dimensional images, and the synthesis unit synthesizes the plurality of two-dimensional images or the plurality of pieces of three-dimensional position information.

A robot device of an aspect of the present disclosure includes the controller described above, a three-dimensional vision sensor including a two-dimensional camera configured to capture an image of an object, and a robot.

### Advantageous Effects of Invention

According to an aspect of the present disclosure, it is possible to provide a controller for a robot device capable of acquiring three-dimensional position information of an object in a short period of time, and a robot device.

### BRIEF DESCRIPTION OF DRAWINGS

FIG. 1 is a perspective view of a first robot device in an embodiment.

FIG. 2 is a block diagram of the first robot device including a first controller.

FIG. 3 is a schematic diagram of a vision sensor in the embodiment.

FIG. 4 is a perspective view of a platform and the vision sensor when changing a position and an orientation of the vision sensor and imaging.

FIG. 5 is a perspective view for explaining three-dimensional points obtained based on an output of the vision sensor.

FIG. 6 is a flowchart of first control for acquiring three-dimensional position information of an object in the embodiment.

FIG. 7 is a block diagram of a processing unit of a second controller of the first robot device in the embodiment.

FIG. 8 is a flowchart of second control for acquiring the three-dimensional position information of the object in the embodiment.

FIG. 9 is a side view of a second robot device in the embodiment.

### DESCRIPTION OF EMBODIMENTS

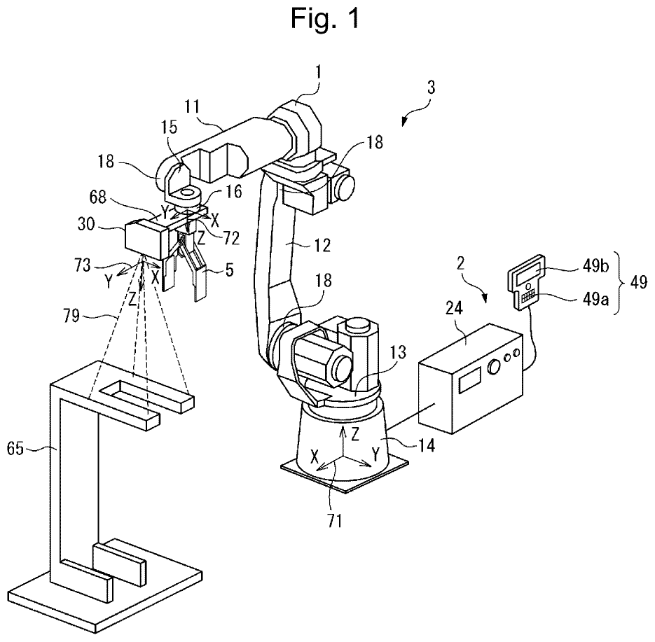

A controller of a robot device and a robot device of an embodiment will be described with reference to FIGS. 1 to 9. The robot device of the present embodiment includes a robot and a three-dimensional vision sensor that acquires three-dimensional position information related to a surface of an object.

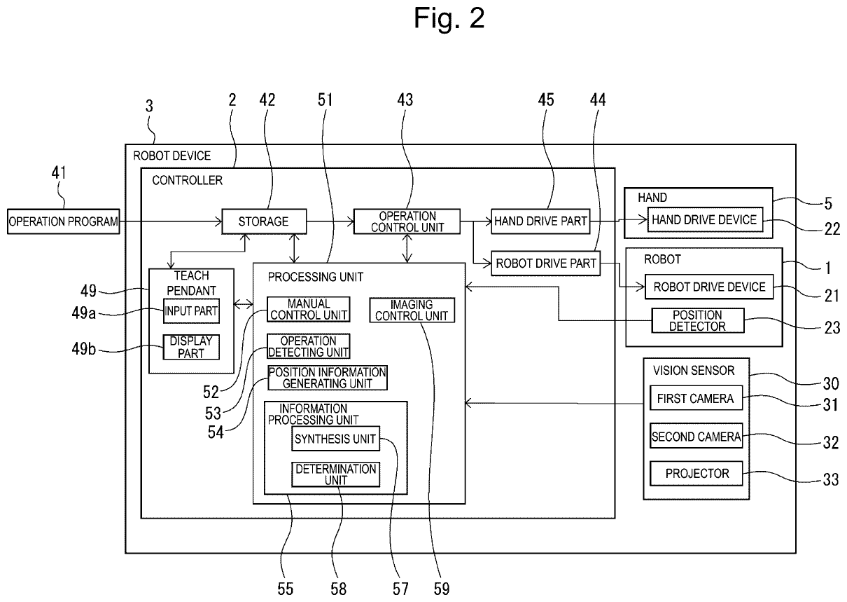

FIG. 1 is a perspective view of a first robot device in the present embodiment. FIG. 2 is a block diagram of the first robot device in the present embodiment. With reference to FIGS. 1 and 2, a first robot device 3 includes a hand 5 as a work tool for gripping a workpiece and a robot 1 that moves the hand 5. The robot device 3 includes a first controller 2 that controls the robot 1 and the hand 5. The robot device 3 includes a vision sensor 30 that is a three-dimensional vision sensor configured to acquire information related to the surface of the object.

The robot 1 of the present embodiment is an articulated robot including a plurality of joints 18. The robot 1 includes an upper arm 11 and a lower arm 12. The lower arm 12 is supported by a swivel base 13. The swivel base 13 is supported by a base 14. The robot 1 includes a wrist 15 connected to an end portion of the upper arm 11. The wrist 15 includes a flange 16 for fixing the hand 5. The robot 1 according to the present embodiment includes six drive axes, but is not limited to this configuration. Any robot that can move a work tool can be employed.

Further, the work tool attached to the robot 1 is not limited to the hand 5, and any work tool can be employed according to the work carried out by the robot device 3. For example, a work tool that performs welding or a work tool that applies a sealing material can be employed.

In the first robot device 3, the vision sensor 30 is attached to the robot 1. The vision sensor 30 is fixed to the flange 16 via a support member 68. The vision sensor 30 of the present embodiment is supported by the robot 1 such that a position and an orientation of the vision sensor 30 are changed together with the hand 5.

The robot 1 of the present embodiment includes a robot drive device 21 that drives constituent members, such as the upper arm 11. The robot drive device 21 includes the upper arm 11, the lower arm 12, the swivel base 13, and a plurality of drive motors for driving the wrist 15. The hand 5 includes a hand drive device 22 that drives the hand 5. The hand drive device 22 of the present embodiment drives the hand 5 by air pressure. The hand drive device 22 includes a pump, an electromagnetic valve, and the like for driving fingers of the hand 5.

The controller 2 includes an arithmetic processing device 24 (a computer) that includes a central processing unit (CPU) as a processor. The arithmetic processing device 24 includes a random access memory (RAM), a read only memory (ROM), and the like which are connected to the CPU via a bus. In the robot device 3, the robot 1 and the hand 5 are driven in accordance with an operation program 41. The robot device 3 of the present embodiment has a function of automatically conveying the workpiece.

The arithmetic processing device 24 of the controller 2 includes a storage 42 that stores information regarding control of the robot device 3. The storage 42 may be constituted by a non-transitory storage medium capable of storing information. For example, the storage 42 may be constituted by a storage medium such as a volatile memory, a nonvolatile memory, a magnetic storage medium, or an optical storage medium. The operation program 41 generated in advance for operating the robot 1 is input to the controller 2. The operation program 41 is stored in the storage 42. The arithmetic processing device 24 includes an operation control unit 43 that controls the operation of the robot. The operation control unit 43 transmits an operation command for driving the robot 1 to a robot drive part 44 based on the operation program 41. The robot drive part 44 includes an electric circuit that drives the drive motors. The robot drive part 44 supplies electricity to the robot drive device 21 in accordance with the operation command. The operation control unit 43 sends an operation command for driving the hand drive device 22 to a hand drive part 45. The hand drive part 45 includes an electric circuit that drives a pump and the like. The hand drive part 45 supplies electricity to the hand drive device 22 based on the operation command.

The operation control unit 43 is equivalent to a processor driven in accordance with the operation program 41. The processor functions as the operation control unit 43 by reading the operation program 41 and implementing control defined in the operation program 41.

The robot 1 includes a state detector for detecting a position and an orientation of the robot 1. The state detector according to the present embodiment includes a position detector 23 attached to the drive motor of each drive axis of the robot drive device 21. The position detector 23 is composed of, for example, an encoder. The position and the orientation of the robot 1 are detected from the output of the position detector 23.

The controller 2 includes a teach pendant 49 as an operation panel on which an operator manually operates the robot device 3. The teach pendant 49 includes an input part 49a for inputting information relating to the robot 1, the hand 5, and the vision sensor 30. The input part 49a is constituted by an operation member such as a keyboard, a dial, and a button. The teach pendant 49 includes the display part 49b that displays information regarding control of the robot device 3. The display part 49b is constituted by a display panel such as a liquid crystal display panel or an organic electro luminescence (EL) display panel.

A robot coordinate system 71 that is immovable is set when the position and the orientation of the robot 1 are changed is set to the robot device 3 of the present embodiment. In the example illustrated in FIG. 1, an origin of the robot coordinate system 71 is arranged at the base 14 of the robot 1. The robot coordinate system 71 is also referred to as a world coordinate system or a reference coordinate system. In the robot coordinate system 71, a position of the origin is fixed and orientations of coordinate axes are also fixed. Even when the position and the orientation of the robot 1 change, a position and an orientation of the robot coordinate system 71 do not change.

In the robot device 3, a flange coordinate system 72 is set at a surface of the flange 16 to which the hand 5 is fixed. An origin of the flange coordinate system 72 is arranged at a rotation axis of the flange 16. In this example, the rotation axis of the flange 16 is set to a Z-axis of the flange coordinate system 72. The flange coordinate system 72 is also called a hand coordinate system. A position of the robot 1 in the present embodiment corresponds to a position of the origin of the flange coordinate system 72 in the robot coordinate system 71. The orientation of the robot 1 corresponds to an orientation of the flange coordinate system 72 with respect to the robot coordinate system 71.

It should be noted that a tool coordinate system may be arranged in the work tool. Then, a position of an origin of the tool coordinate system in the robot coordinate system 71 may be set as the position of the robot, and an orientation of the tool coordinate system with respect to the robot coordinate system 71 may be set as the orientation of the robot.

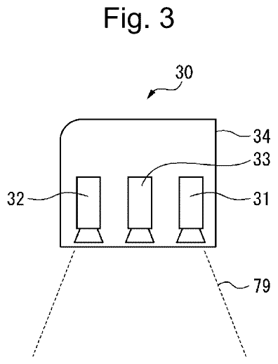

FIG. 3 is a schematic view of the vision sensor of the present embodiment. With reference to FIGS. 2 and 3, the vision sensor 30 in the present embodiment is a three-dimensional vision sensor (three-dimensional camera) that can acquire three-dimensional position information related to a surface of an object. The vision sensor 30 according to the present embodiment is a stereo camera including a first camera 31 and a second camera 32. Each of the cameras 31, 32 is a two-dimensional camera that can capture a two-dimensional image. The two cameras 31, 32 are arranged apart from each other. Relative positions of the two cameras 31, 32 are predetermined. The vision sensor 30 of the present embodiment includes a projector 33 configured to project a pattern light such as a stripe pattern toward the workpiece. The cameras 31, 32 and the projector 33 are arranged inside a housing 34.

With reference to FIG. 1, in the robot device 3, a sensor coordinate system 73 is set for the vision sensor 30. The sensor coordinate system 73 is a coordinate system whose origin is fixed to any position of the vision sensor 30. A position and an orientation of the sensor coordinate system 73 are changed together with the vision sensor 30. The sensor coordinate system 73 according to the present embodiment is set such that the Z-axis is parallel to an optical axis of a camera included in the vision sensor 30. The sensor coordinate system 73 is configured to move and rotate together with the flange coordinate system 72. A position of the origin of the sensor coordinate system 73 in the flange coordinate system 72 and the orientation of the sensor coordinate system 73 with respect to the flange coordinate system 72 are determined in advance.

With reference to FIG. 2, an arithmetic processing device 24 of the controller 2 in the present embodiment includes a processing unit 51 that performs arithmetic processing. The processing unit 51 includes a manual control unit 52 that generates an operation command for manually driving the robot 1 and the hand 5 in response to an operation of the teach pendant 49 by the operator. The manual control unit 52 sends the operation command for the robot 1 and the hand 5 to the operation control unit 43. The operator can change the position and the orientation of the robot in a desired direction by operating the input part 49a of the teach pendant 49.

For example, when a button of the input part 49a is pressed, it is possible to perform a jogging operation that moves the position of the robot or rotates the robot in a direction of the coordinate axis of the coordinate system corresponding to the button. In the jogging operation, the robot is driven while the button is pressed. It should be noted that the operation control unit 43 may have the function of the manual control unit 52.

The processing unit 51 includes an operation detecting unit 53 that detects an operation state of the robot 1. The operation detecting unit 53 detects a state in which the robot 1 is operating based on, for example, the output of the position detector 23. Alternatively, the operation detecting unit 53 may acquire an operation command transmitted from the operation control unit 43 and detect the operation state of the robot 1. The operation detecting unit 53 of the present embodiment can detect whether the robot 1 is driven or whether the robot 1 is stopped.

The processing unit 51 includes a position information generating unit 54 that generates three-dimensional position information related to the object based on a two-dimensional image acquired from the vision sensor 30. As will be described below, the three-dimensional position information can be exemplified by a distance image or a three-dimensional map representing the surface of the object. The position information generating unit 54 has a function of converting the position information of the surface of the object acquired in the sensor coordinate system 73 into the position information of the surface of the object represented in the robot coordinate system 71. The position information generating unit 54 has, for example, a function of converting a position (coordinate values) of a three-dimensional point in the sensor coordinate system 73 into a position (coordinate values) of a three-dimensional point in the robot coordinate system 71 based on the position and the orientation of the robot 1.

The processing unit 51 includes an imaging control unit 59 that controls imaging of the vision sensor 30. The imaging control unit 59 controls a time period of imaging by the vision sensor 30. The imaging control unit 59 changes an exposure condition of the two-dimensional camera included in the vision sensor 30. The exposure condition in the present embodiment includes an exposure time (shutter speed) of the two-dimensional camera.

Further, the robot device may include an illumination device for illuminating the object. The illumination device may be fixed around the object. Further, the illumination device may be fixed to the robot 1 and move together with driving of the robot 1. The imaging control unit 59 can be formed so as to adjust a brightness of the illumination. In this case, at least one selected from a group of the exposure time of the two-dimensional camera and an amount of light of the illumination device can be employed as the exposure condition.

The processing unit 51 includes an information processing unit 55 that processes the three-dimensional position information generated by the position information generating unit 54. Alternatively, the information processing unit 55 processes a two-dimensional image obtained by the two-dimensional camera of the vision sensor 30. The information processing unit 55 includes a synthesis unit 57 that synthesizes two-dimensional images or three-dimensional position information. The synthesis unit 57 synthesizes a plurality of the two-dimensional images captured by the two-dimensional camera so as to correct a defect in a two-dimensional image, or the synthesis unit 57 synthesizes a plurality of pieces of the three-dimensional position information generated by the position information generating unit 54 so as to correct a defect in the three-dimensional position information.

The information processing unit 55 includes a determination unit 58 that determines whether or not a defect exists in the two-dimensional image or three-dimensional position information. When making a determination of the two-dimensional image, the determination unit 58 in the present embodiment determines whether or not the two-dimensional image has a defect such as halation or black crushing. For example, when all pixels inside a region having a predetermined size have a pixel value of halation or black crushing, the determination unit 58 determines that the region is defective.

On the other hand, when determining the three-dimensional position information, the determination unit 58 determines whether or not a defect exists in which some of the distance information is missing. For example, the determination unit 58 determines whether or not distance information is missing for each pixel. The determination unit 58 determines that a defect exists in the three-dimensional position information when distance information is missing in some of the pixels.

The processing unit 51 described above is equivalent to a processor that is driven in accordance with the operation program 41. The manual control unit 52, the operation detecting unit 53, the position information generating unit 54, the information processing unit 55, the synthesis unit 57, the determination unit 58, and the imaging control unit 59 included in the processing unit 51 are equivalent to a processor that is driven in accordance with the operation program 41. The processor functions as each unit by reading the operation program 41 and implementing the control that is defined by the operation program 41.

The robot device 3 in the present embodiment acquires three-dimensional position information of a peripheral object such as a device such as a conveyor or a robot, a fence, and a platform arranged around the robot 1 before carrying out the work of conveying an actual workpiece. In other words, stereoscopic information of the peripheral object arranged around the robot 1 is acquired. In this case, acquisition of three-dimensional position information of the surface of a platform 65 for fixing the workpiece will be described.

The three-dimensional position information of the objects around the robot 1 is acquired, for example, before off-line simulation of the robot device is implemented. A display part of the simulation device can display a stereoscopic image based on the three-dimensional position information of the peripheral object. The operator can, while viewing the image of the peripheral object, generate an operation path of the robot in the actual work so that the robot, the hand, and the workpiece do not come into contact with the peripheral object. Alternatively, the simulation device may have a function of automatically generating the operation path. In this case, the operator designates a start point and an end point of the operation of the robot based on the three-dimensional position information of the peripheral object. Then, the simulation device can automatically generate the operation path of the robot so that the robot does not interfere with the peripheral object.

Alternatively, the controller of the robot device can store the three-dimensional position information of the peripheral object arranged around the robot device. The controller can determine whether or not the robot device will come into contact with the peripheral object. For example, when the operator operates the teach pendant and manually drives the robot, the controller can determine whether or not the robot device will come into contact with the peripheral object. The controller implements control for preventing the driving of the robot upon determination that the robot device will come into contact with the peripheral object. Alternatively, the controller can perform control for decelerating or stopping the robot when the robot device approaches the peripheral object. Furthermore, the controller can display a warning indicating to stop the robot on the display part of the teach pendant.

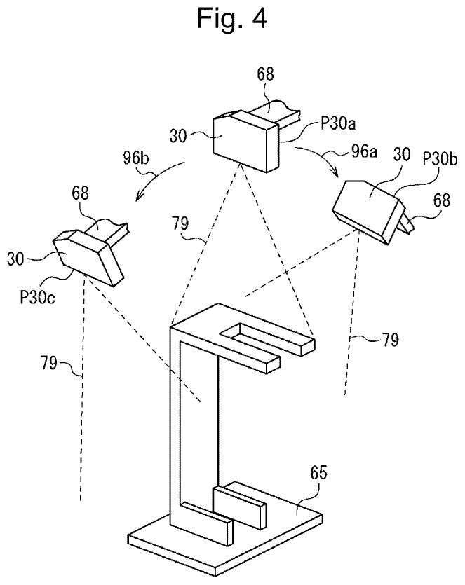

FIG. 4 illustrates a perspective view of the vision sensor and the platform when acquiring the three-dimensional position information of the surface of the platform. With reference to FIGS. 2 and 4, in first control in the present embodiment, the operator manually drives the robot 1. The operator operates the input part 49a of the teach pendant 49. The manual control unit 52 changes the position and the orientation of the robot in response to the operation of the input part 49a.

In the example illustrated in FIG. 4, the operator arranges the vision sensor 30 at a position P30a by a jogging operation. Subsequently, as indicated by arrows 96a, 96b, the position and the orientation of the vision sensor 30 are changed to a position P30b and a position P30c. The imaging control unit 59 causes the cameras 31, 32 to capture images at a predetermined interval during a period in which the vision sensor 30 is moving. In an imaging region 79 of the vision sensor 30, a three-dimensional point can be generated at the surface facing the vision sensor 30. The operator changes the position and the orientation of the robot 1 so that all surfaces for which three-dimensional position information is required are imaged by the cameras 31, 32. In this case, in order to generate three-dimensional position information for all surfaces of the platform 65 that are visible, images are captured at various positions and orientations so as to capture images of all surfaces of the platform 65.

The position information generating unit 54 sets a three-dimensional point on a surface of the object included in an image based on two-dimensional images acquired by the first camera 31 and the second camera 32. The position information generating unit 54 calculates a distance from the vision sensor 30 to a three-dimensional point set on a surface of an object based on parallax between an image captured by the first camera 31 and an image captured by the second camera 32. The three-dimensional point can be set for each pixel of an image sensor, for example. Furthermore, the position information generating unit 54 calculates coordinate values of a position of a three-dimensional point in the sensor coordinate system 73 based on the distance from the vision sensor 30.

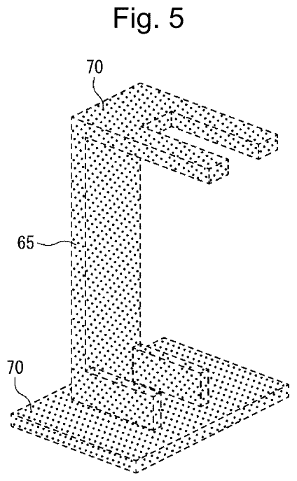

FIG. 5 is a perspective view of a three-dimensional point cloud generated by the position information generating unit. FIG. 5 is a perspective view of three-dimensional points arranged in a three-dimensional space. In FIG. 5, a contour of the platform 65 is indicated by dashed lines. A three-dimensional point 70 is arranged on a surface of the object facing the vision sensor 30. The position information generating unit 54 sets the three-dimensional point 70 with respect to the surface of the object included in the imaging region 79. In this case, a large number of the three-dimensional points 70 are arranged on the surface of the platform 65.

The position information generating unit 54 can present three-dimensional position information related to the surface of the object in a perspective view of the group of the three-dimensional points as in FIG. 5. Further, the position information generating unit 54 can generate the three-dimensional position information of the surface of the object in a form of a distance image or a three-dimensional map. The distance image represents the position information about the surface of the object by a two-dimensional image. The distance image indicates distances from the vision sensor 30 to the three-dimensional points by depths or colors of respective pixels. On the other hand, the three-dimensional map represents the position information about the surface of the object by a set of coordinate values (x, y, z) of the three-dimensional points on the surface of the object. These coordinate values can be represented using any arbitrary coordinate system such as the sensor coordinate system 73 or the robot coordinate system 71.

In the present embodiment, three-dimensional position information of the surface of the object will be described by mainly using a distance image as an example. The position information generating unit 54 of the present embodiment generates a distance image in which depth of color is changed in response to distances from the vision sensor 30 to the three-dimensional points 70.

It should be noted that the position information generating unit 54 of the present embodiment is arranged at the processing unit 51 of the arithmetic processing device 24, but is not limited to this configuration. The position information generating unit may be arranged inside the vision sensor. In other words, the vision sensor may include an arithmetic processing device including a processor such as a CPU, and the processor of the arithmetic processing device of the vision sensor may function as the position information generating unit. In that case, a three-dimensional map, a distance image, or the like is output from the vision sensor.

The processing unit 51 of the present embodiment is formed so as to implement automatic imaging control in which imaging by the vision sensor 30 is performed or the imaging is stopped in response to the driving state of the robot 1. Automatic imaging control of the present embodiment includes normal imaging control and synthesis control.

The operation detecting unit 53 detects whether or not the robot 1 is in operation. Normal imaging control is implemented during a period in which the operation detecting unit 53 detects the operation of the robot 1. In normal imaging control, the imaging control unit 59 causes the cameras 31, 32 to capture two-dimensional images at a predetermined interval. The imaging control unit 59 obtains images by imaging during a period in which the position and the orientation of the vision sensor 30 are changed. Further, the imaging control unit 59 obtains two-dimensional images by imaging under the same predetermined exposure condition.

The imaging control unit 59 can obtain images by imaging at a predetermined time interval. For example, the imaging control unit 59 causes the cameras 31, 32 to capture images at a time interval within a range from 300 msec to 500 msec. The predetermined interval is not limited to an interval of time, and may be an interval of a movement distance of a predetermined portion. For example, the movement distance of the position of the origin of the flange coordinate system of the robot may be employed. Alternatively, the predetermined interval may be an interval of a rotation angle of a predetermined portion. Further, the predetermined interval need not be a constant interval. The position information generating unit 54 generates three-dimensional position information at a predetermined interval.

As the exposure condition in normal imaging control, any exposure condition under which an image can be captured without blurring can be employed. For example, a predetermined constant exposure condition can be employed. The exposure time is preferably shortened so that the two-dimensional image is not blurred. For this reason, for example, preferably the amount of light of the illumination device is maximized and a fast shutter speed is set. The operator maximizes the amount of light of the illumination device and moves the camera so as to capture an image of a portion of the object having an intermediate brightness. Then, the minimum exposure time during which a two-dimensional image can be captured can be set. In other words, the maximum shutter speed can be determined in response to the brightness of the illumination device.

In the present embodiment, the object is imaged from various positions and directions, and thus defects such as halation or black crushing may occur in the two-dimensional image depending on a position of the illumination device, a direction of the vision sensor, a material of the surface of the object, a shape of the surface of the object, and the like. Three-dimensional position information cannot be created for a portion having a defect in a two-dimensional image. Therefore, the information processing unit 55 of the present embodiment implements synthesis control for compensating for a defect in the two-dimensional image or the three-dimensional position information.

The operation detecting unit 53 detects whether or not the robot 1 is in operation. When the operation detecting unit 53 detects the stopping of the robot 1, synthesis control is implemented. In synthesis control, the imaging control unit 59 automatically changes the exposure condition and obtains a plurality of two-dimensional images by imaging. For example, the imaging control unit 59 obtains the plurality of two-dimensional images by imaging while changing the exposure time from 0.1 msec to 100 msec in increments of 10×. Alternatively, the imaging control unit 59 may change the amount of light of the illumination device. For example, the imaging control unit 59 causes the cameras 31, 32 to capture the plurality of images while increasing the amount of light from 0% (off) to 100% (fully on) in increments of 10%. This imaging is performed by both the first camera 31 and the second camera 32.

Next, the position information generating unit 54 generates a plurality of pieces of three-dimensional position information from the two-dimensional images under a plurality of exposure conditions. Then, the synthesis unit 57 synthesizes the plurality of pieces of three-dimensional position information to generate one piece of three-dimensional position information. Alternatively, the synthesis unit 57 synthesizes the two-dimensional images under the plurality of exposure conditions for each image of the respective cameras 31, 32. The position information generating unit 54 may generate the three-dimensional position information based on two two-dimensional images synthesized for each camera 31, 32.

In this example, the position information generating unit 54 generates a distance image corresponding to the exposure condition based on the two-dimensional image corresponding to the exposure conditions. The position information generating unit 54 generates a plurality of the distance images. Then, the synthesis unit 57 synthesizes the plurality of distance images.

As a method of synthesizing the distance images, a pixel for which three-dimensional position (distance information) is missing in one distance image can be complemented with a three-dimensional position of a pixel of a distance image obtained by imaging under another exposure condition. For example, the synthesis unit 57 selects one distance image having an intermediate exposure condition. The synthesis unit 57 identifies a pixel for which distance information does not exist. Then, the synthesis unit 57 can acquire the distance information of a distance image acquired under another exposure condition for the pixel for which the distance information does not exist. Alternatively, the synthesis unit 57 deletes a pixel for which distance information is missing in the plurality of distance images. The synthesis unit 57 may calculate an average value of the distance information of the plurality of distance images for all pixels for which the distance information exists.

It should be noted that, when the three-dimensional position information is a three-dimensional map, the coordinate values of the respective three-dimensional points can be complemented or averaged. In this way, the synthesis unit can synthesize the plurality of pieces of three-dimensional position information and generate synthesized position information that is three-dimensional position information after synthesis.

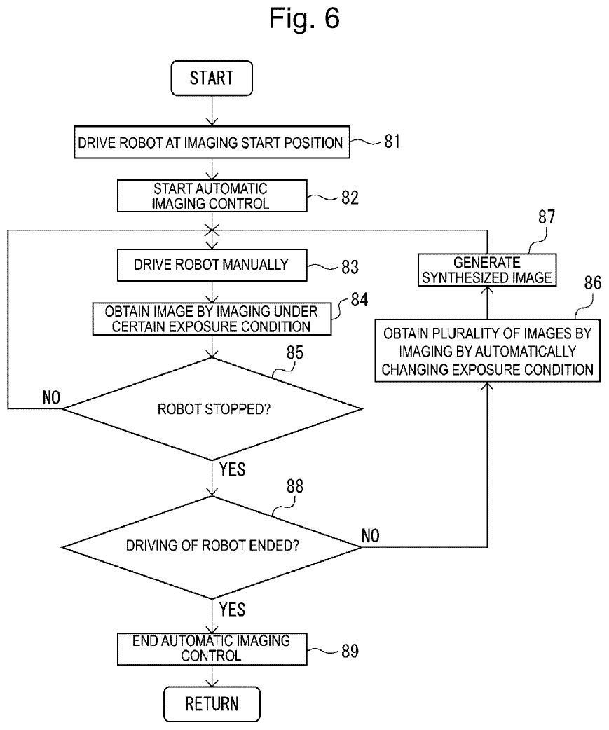

FIG. 6 illustrates a flowchart of the first control in the present embodiment. In the first control, the operator manually drives the robot 1 by a jogging operation to implement normal imaging control. The display part 49b of the teach pendant 49 displays the distance image. Then, the operator determines whether or not a defect exists in the distance image. When a defect exists in the distance image, synthesis control is implemented when the operator manually stops the robot 1.

In step 81, the operator operates the teach pendant 49, driving the robot 1 to the position and the orientation at which imaging is started. For example, with reference to FIG. 4, in response to an operation by the operator, the manual control unit 52 drives the robot 1 so that the vision sensor 30 is arranged at the position P30a. The vision sensor 30 is arranged at the position P30a directly above the platform 65 serving as the object.

In step 82, automatic imaging control is started. The operator, by operating the input part 49a, transmits a command for starting automatic imaging control to the imaging control unit 59 and the operation detecting unit 53. In step 83, the operator manually drives the robot 1. For example, as indicated by the arrow 96a, the position and the orientation of the vision sensor 30 are changed from the position P31a to the position P30b.

In step 84, the operation detecting unit 53 detects the driving of the robot 1. The imaging control unit 59 implements normal imaging control for capturing two-dimensional images at a predetermined interval under a predetermined exposure condition. The position information generating unit 54 generates three-dimensional position information using the two-dimensional images captured by the cameras 31, 32. In this case, the position information generating unit 54 generates a distance image. The display part 49b of the teach pendant 49 displays the distance image each time the distance image is generated.

The operator views the distance image displayed on the display part 49b during the period of driving the robot 1. The operator determines whether or not a defect exists in the distance information. Distance information is not generated in a portion in which a defect exists in the two-dimensional image. For example, the position of the three-dimensional point is not calculated in the sensor coordinate system 73. In the distance image, a defective pixel for which distance information is missing is displayed at a predetermined density. For example, when the distance image is created so that a color density changes in response to distance, the defective pixel is displayed in the darkest color. The operator can easily determine whether or not the distance information is missing by viewing the distance image.

When the operator determines that there is no defect in the distance image, the operator continues to manually drive the robot. In step 85, the operation detecting unit 53 determines that the robot 1 is not stopped. The control then returns to step 83. In steps 83, 84, the driving of the robot 1 and the generation of the distance image are continued.

On the other hand, during the period of driving the robot 1, when the operator determines that a defect exists in the distance image, the operator performs an operation of manually stopping the robot 1. In other words, the jogging operation of the robot 1 is interrupted and the movement of the vision sensor 30 is stopped. In step 85, the operation detecting unit 53 detects the stopping of the robot 1. Normal imaging control is stopped by an operation by the operator. In this case, the control proceeds to step 88.

In step 88, the imaging control unit 59 determines whether or not the driving of the robot 1 has ended. When imaging of the object from various directions is completed, the driving of the robot 1 is ended. In this case, the operator, by operating the teach pendant 49, sends a command for ending the driving of the robot 1 to the processing unit 51. When the driving of the robot 1 has not ended, the control proceeds to step 86.

In step 86, the imaging control unit 59 starts synthesis control. The imaging control unit 59 changes the exposure condition and obtains a plurality of two-dimensional images. In this case, the position information generating unit 54 generates a distance image corresponding to the exposure condition each time imaging is performed by the two-dimensional camera. In step 87, the synthesis unit 57 of the information processing unit 55 generates a synthesized distance image as three-dimensional position information from the plurality of distance images. By this control, a synthesized distance image in which no defect exists is generated. The display part 49b displays the synthesized image generated by the synthesis unit 57. The operator can confirm the image displayed on the display part 49b. Subsequently, the control returns to step 83. The operator resumes the manual driving of the robot. When the operation detecting unit 53 detects the restart of the driving of the robot 1, synthesis control is stopped and normal imaging control is started.

In step 88, when the manual driving of the robot 1 is completed, the control proceeds to step 89. In other words, when imaging from various directions is completed, the control proceeds to step 89. In step 89, the operator, by operating the input part 49a of the teach pendant 49, transmits a command for ending automatic imaging control to the imaging control unit 59 and the operation detecting unit 53, and the control ends.

The operator can change the position and the orientation of the vision sensor 30 so that the desired surface of the platform 65 is imaged in its entirety. Then, the three-dimensional position information of the surface of the platform 65 can be acquired by imaging from various angles. The position information generating unit 54 can convert the three-dimensional position information acquired in the sensor coordinate system 73 into three-dimensional position information in the robot coordinate system 71. The processing unit 51 can store, in the storage 42, the position and the orientation of the vision sensor 30 and the three-dimensional position information. Furthermore, the processing unit 51 can generate three-dimensional position information (refer to FIG. 5) related to the surface of the platform 65 by integrating or averaging the plurality of pieces of three-dimensional position information acquired at the plurality of positions and orientations of the robot 1.

It should be noted that, in the embodiment described above, the synthesis unit 57 synthesizes a plurality of distance images to generate a synthesized distance image. However, the configuration is not limited thereto. For example, the synthesis unit 57 may synthesize the plurality of two-dimensional images captured by the first camera 31 and the second camera 32. As a method of synthesizing the two-dimensional images, any synthesis method that increases the dynamic range can be employed.

For example, the synthesis unit 57 can synthesize the two-dimensional images by a high dynamic range (HDR) method. By changing the exposure condition and synthesizing the plurality of two-dimensional images, it is possible to obtain a two-dimensional synthesized image having a large dynamic range. The synthesis unit 57 synthesizes the two-dimensional images for each of the cameras 31, 32 to generate synthesized two-dimensional images. Subsequently, the position information generating unit 54 may generate three-dimensional position information of a distance image or the like based on the synthesized two-dimensional image of the first camera 31 and the synthesized two-dimensional image of the second camera 32.

Thus, when a defect does not exist in the distance image, the operator can automatically repeat the imaging and the generation of the distance image until the driving of the robot ends. Upon finding a defect in the distance image, the operator stops driving the robot 1. By this operation, the processing unit captures a plurality of images for which the exposure condition was changed, and automatically synthesizes the three-dimensional position information or the two-dimensional images. Then, the synthesized position information obtained by synthesizing the three-dimensional position information or the three-dimensional position information generated from the synthesized two-dimensional image obtained by synthesizing the two-dimensional images can be generated. The operator, even without performing an operation of capturing a plurality of images, an operation of generating a synthesized image, or the like, can generate three-dimensional position information of a desired portion of the object by an operation of driving the robot. This makes it possible to easily generate three-dimensional position information of the object.

Further, the robot is stopped when a defect exists in the two-dimensional image or the three-dimensional position information, making it possible to shorten the time required for stopping the robot. As a result, the three-dimensional position information of the peripheral object can be generated in a short period of time. Further, the three-dimensional position information of the peripheral object can be easily generated.

It should be noted that, when viewing the synthesized distance image displayed on the display part 49b, the operator may input a command to the teach pendant for changing the synthesis method when a defect remains in the synthesized distance image. The processing unit 51 can then change the synthesis method and display the synthesized distance image on the display part 49b. For example, the processing unit 51 can change the method of synthesizing the distance images to a method of synthesizing the two-dimensional images. Then, the operator may resume the driving of the robot when a synthesized distance image with a small number of defects is obtained. By this control, the three-dimensional position information with a small number of defects can be more reliably obtained.

It should be noted that, when the robot is manually driven, the vision sensor may be temporarily stopped in order to change the moving direction of the vision sensor. For example, with reference to FIG. 4, the vision sensor 30 may be moved from the position P30a to the position P30b and then returned to the position P30a. In order to change the moving direction, the vision sensor 30 is temporarily stopped at the position P30b. In this case, synthesis control is implemented in automatic imaging control. Even if the synthesized position information is unnecessary, the synthesized position information is generated. However, with employment of the synthesized position information as the three-dimensional position information being unproblematic, synthesis control may be implemented.

With reference to FIG. 2, the information processing unit 55 in the present embodiment includes the determination unit 58 that determines whether or not a defect exists in the two-dimensional image or the three-dimensional position information. Therefore, instead of the operator determining whether or not a defect exists in the three-dimensional position information, the determination unit 58 can automatically make the determination.

The determination unit 58 determines whether or not there is a pixel without distance information in the three-dimensional position information generated in normal imaging control. Then, when there is a pixel without distance information, the determination unit 58 can determine that a defect exists in the three-dimensional position information. The determination unit 58 can make this determination for each piece of three-dimensional position information created.

Alternatively, the determination unit 58 can determine whether or not a defect exists in the two-dimensional images captured by the cameras 31, 32. For example, the determination unit 58 determines a pixel having a white pixel value that deviates from a predetermined determination range or a pixel having a black pixel value that deviates from a predetermined determination range as a defective pixel. When all pixels inside a region of a predetermined size have defective pixel values, the determination unit 58 determines that halation or black crushing occurred in the region. In other words, the determination unit 58 determines that a defect exists in the two-dimensional image.

When the determination unit 58 determines that a defect exists in the three-dimensional position information or the two-dimensional image, the manual control unit 52 transmits a command for stopping the driving of the robot 1 to the operation control unit 43, regardless of the operation of the teach pendant 49 by the operator. The operation control unit 43 then stops the robot 1. By this control, the stopping of the robot 1 is detected, and the imaging control unit 59 implements synthesis control. The imaging control unit 59 automatically changes the exposure condition and captures a plurality of two-dimensional images. Then, the synthesis unit 57 can synthesize the two-dimensional images or the three-dimensional position information.

Thus, the determination unit 58 may automatically determine the presence of a defect in the three-dimensional position information or the two-dimensional image and forcibly stop the robot 1. After the synthesis unit 57 completes the synthesis of the two-dimensional images or the three-dimensional position information, the manual control unit 52 cancels the forcible stop of the robot 1. The manual control unit 52 resumes the driving of the robot 1 in response to an operation of the teach pendant 49 by the operator. In other words, the operator can perform a jogging operation by operating the input part 49a of the teach pendant 49. The driving of the robot 1 is then detected by the operation detecting unit 53, and normal imaging control is resumed.

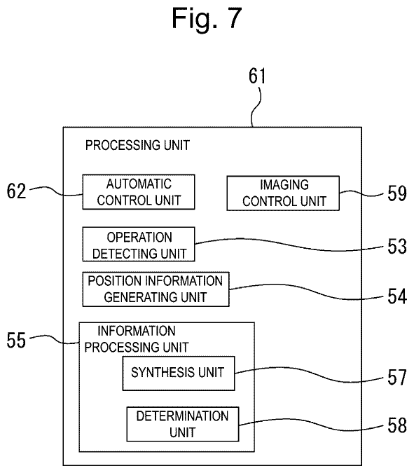

FIG. 7 illustrates a block diagram of a processing unit of a second controller of the first robot device in the embodiment. The second controller automatically drives the robot in order to acquire the three-dimensional position information of the object. The operator creates in advance an operation program for automatically driving the robot 1. Then, the robot is driven in accordance with the operation program, and an image is captured by the vision sensor 30 by automatic imaging control in order to acquire the three-dimensional position information of the peripheral object.

A processing unit 61 includes an automatic control unit 62 that generates an operation command for automatically driving the robot 1 in accordance with a predetermined operation program. The automatic control unit 62 sends the operation command to the operation control unit 43. The operation control unit 43 drives the robot based on the operation command from the automatic control unit 62. It should be noted that the operation control unit 43 may have the function of the automatic control unit 62. Other configurations of the processing unit 61 are similar to the configurations of the processing unit 51 of the first controller 2 (refer to FIG. 2).

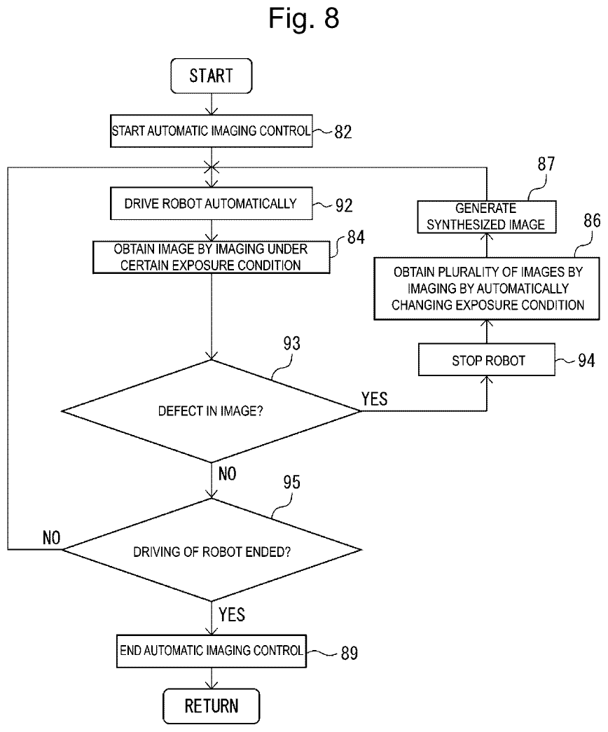

FIG. 8 illustrates a flowchart of the control of the second controller in the present embodiment. The second controller implements second control for automatically driving the robot 1 to capture an image. The operator creates in advance an operation program that defines an operation path along which the robot 1 is driven. For example, as illustrated in FIG. 4, an operation program that defines an operation path by which the vision sensor 30 passes through the position P30a, the position P30b, and the position P30c is created.

The operation path of the robot included in the operation program is preferably a path along which the object can be imaged at various positions and orientations of the vision sensor 30 so that three-dimensional position information of a desired surface of the object can be acquired.

In step 82, the operator operates the teach pendant 49, thereby starting automatic imaging control. In step 92, the operator operates the teach pendant 49, thereby starting the automatic driving of the robot. The automatic control unit 62 transmits operation commands for the robot 1 to the operation control unit 43 in accordance with the operation program. The position and the orientation of the robot 1 change, changing the position and the orientation of the vision sensor 30.

In step 84, the operation detecting unit 53 detects the driving of the robot 1, and then the imaging control unit 59 implements normal imaging control. Two-dimensional images of the object are captured by normal imaging control and the three-dimensional position information is generated. In this example, a distance image is generated.

In step 93, during the period in which the robot 1 is driven by the operation command of the automatic control unit 62, the determination unit 58 determines whether or not a defect exists in the two-dimensional image or the three-dimensional position information. In this example, whether or not a defect exists in the distance image is determined. In step 93, when a defect does not exist in the two-dimensional image or the three-dimensional position information, the control proceeds to step 95.

In step 95, the imaging control unit 59 determines whether or not the driving of the robot 1 has ended. In other words, the determination is made as to whether or not the robot 1 has been driven to an end point of the operation path in the operation program. In step 95, when the driving of the robot 1 has not ended, the control proceeds to step 92. In this way, it is possible to generate the three-dimensional position information of the surface of the object while automatically driving the robot 1 based on an operation program created in advance.

On the other hand, in step 93, when the determination unit 58 determines that a defect exists in the two-dimensional image or the three-dimensional position information, the control proceeds to step 94. In step 94, the automatic control unit 62 sends a command for stopping the robot 1. The operation detecting unit 53 detects the stopping of the robot 1, and the imaging control unit 59 implements synthesis control. In steps 86, 87, the synthesis unit 57 synthesizes the two-dimensional images or the three-dimensional position information. In this example, the synthesis unit 57 generates, as the three-dimensional position information in which the defect is corrected, a synthesized distance image from the plurality of distance images.

Subsequently, the automatic control unit 62 cancels the command for stopping the robot 1. Then, the control returns to step 92. In order to automatically drive the robot 1, synthesis control is stopped and normal imaging control is started.

In step 95, when the driving of the robot 1 has ended, the control proceeds to step 89. In step 89, the operator, by operating the input part 49a of the teach pendant 49, transmits a command for ending automatic imaging control to the processing unit 61, and the control ends.

Thus, in the second control of the second controller, the three-dimensional position information of the object can be automatically generated in order to automatically drive the robot 1. It should be noted that a command statement for starting automatic imaging control and a command statement for stopping automatic imaging control may be described in the operation program. By this control, automatic imaging control can be automatically started or ended in accordance with the operation program.

Other configurations, actions, and effects of the second controller are similar to those of the first controller, and the description thereof will not be repeated here.

Incidentally, in normal imaging control of the present embodiment, a two-dimensional image is captured while driving the robot 1. Therefore, when the speed at which the robot 1 is driven is high, the two-dimensional image may be blurred. Therefore, in normal imaging control, it is possible to implement control for changing the exposure time in advance in response to the driving speed of the robot 1.

During the period in which the operation detecting unit 53 detects the operation of the robot 1, the imaging control unit 59 can determine whether or not the speed at which the robot 1 is driven with respect to the exposure time of the cameras 31, 32 exceeds a predetermined determination value. When the speed at which the robot 1 is driven with respect to the exposure time of the cameras 31, 32 exceeds the predetermined determination value, the imaging control unit 59 can implement control for shortening the exposure time of the cameras 31, 32.

For example, the imaging control unit 59 calculates a variable obtained by multiplying a movement speed (unit: mm/sec) of the vision sensor 30 by the exposure time (unit: sec) of the cameras 31, 32. This variable is equivalent to the distance across which the vision sensor 30 moves during exposure. When the variable exceeds a predetermined determination value, the imaging control unit 59 determines that the speed at which the robot 1 is driven with respect to the exposure time of the cameras 31, 32 exceeds the predetermined determination value. Then, the imaging control unit 59 implements control for shortening the current exposure time. For example, the imaging control unit 59 implements control for decreasing the exposure time by a predetermined ratio. Alternatively, the operator can create a table of exposure times with respect to the value of the variable described above in advance. The imaging control unit 59 may implement control for shortening the exposure time based on this table.

In the first robot device 3 described above, the vision sensor 30 is attached to the robot 1. Then, the object for acquiring the three-dimensional position information is an object arranged around the robot 1. By employing this configuration, it is possible to easily acquire the three-dimensional position information of the object arranged around the robot 1 by changing the position and the orientation of the robot.

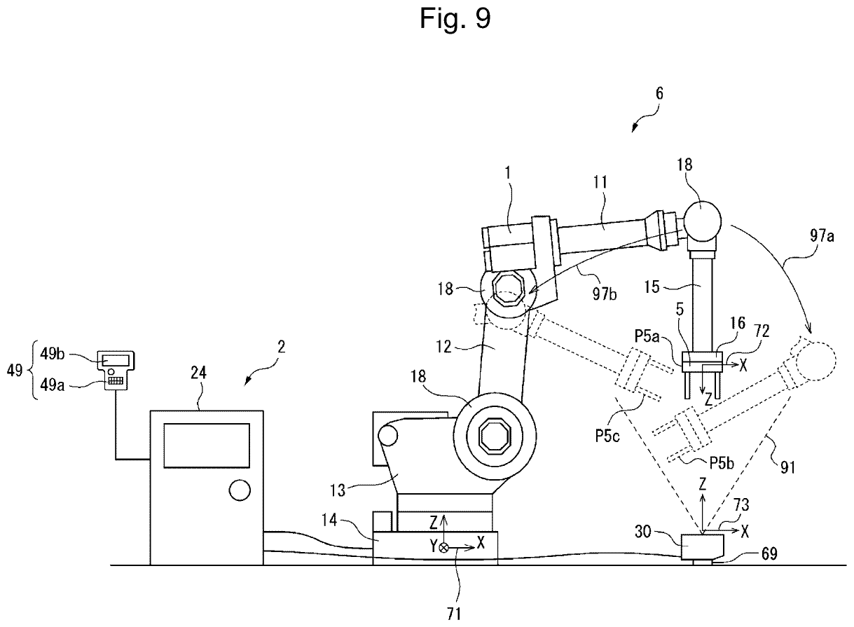

FIG. 9 illustrates a schematic side view of a second robot device of the present embodiment. In a second robot device 6, the position and the orientation of the vision sensor 30 are fixed. The vision sensor 30 is fixed to an installation surface of the robot 1 by a support member 69. The hand 5 is attached to the robot 1 as a work tool.

In the second robot device 6, the hand 5 is equivalent to an object from which the three-dimensional position information is acquired. The controller of the second robot device 6 images the surface of the hand 5 at various positions and orientations of the hand 5. The controller generates three-dimensional position information related to the surface of the hand 5 based on an output of the vision sensor 30.

A configuration of the controller of the robot device is similar to that of the first controller 2 or the second controller (refer to FIGS. 2 and 7) of the first robot device. When the operator is to manually drive the robot 1, the processing unit 51 illustrated in FIG. 2 can be employed. When the robot 1 is to be automatically driven by the operation program, the processing unit 61 illustrated in FIG. 7 can be employed.

In the second robot device 6, the robot 1 is driven manually or automatically as indicated by arrows 97a, 97b. For example, the hand 5 is moved to a position P5a, a position P5b, and a position P5c. The controller implements automatic imaging control during a period in which the driving of the robot 1 is automatically controlled. In other words, it is possible to implement normal imaging control during a period in which the robot 1 is driven, and implement synthesis control when the robot 1 is stopped. In either case of manual operation or automatic operation, an image of the hand 5 is captured as an object to be imaged by the vision sensor 30. The position and the orientation of the robot 1 are changed so as to capture images of all surfaces of the hand 5 for which the three-dimensional position information is required.

The three-dimensional position information of the surface of the hand 5 can be acquired by driving the robot 1 and imaging the hand 5 from various directions. Furthermore, it is possible to acquire the position information of the surface of the hand 5 with respect to the position and the orientation of the robot 1 based on the respective positions and the orientations of the robot 1 when the three-dimensional position information is acquired. For example, it is possible to calculate the position of a three-dimensional point set at the surface of the hand 5 in the flange coordinate system 72.

The operator can perform off-line simulation using the three-dimensional position information of the hand 5. For example, the operation path of the robot 1 is generated so that the hand 5 does not come into contact with a peripheral object. Alternatively, in a simulation device that automatically generates the operation path of the robot, the operation path of the robot 1 can be automatically generated so that the hand 5 does not come into contact with a peripheral object.

Other configurations, actions, and effects of the second robot device are similar to those of the first robot device, and thus description thereof will not be repeated here.

The three-dimensional vision sensor of the present embodiment is a stereo camera, but is not limited to this configuration. For example, any vision sensor including a two-dimensional camera can be employed as the vision sensor. For example, a vision sensor that detects a three-dimensional position of an object by a phase shift method can be employed. Alternatively, a sensor that acquires a two-dimensional image of an object for which a distance to the object is known and calculates the position of a three-dimensional point at the surface of the object can be employed as the three-dimensional vision sensor.

In each of the above-described controls, the order of steps can be changed appropriately to the extent that the function and action are not changed.

The above embodiments can be combined as appropriate. In each of the above-described drawings, the same or equivalent parts are denoted by the same sign. It should be noted that the above embodiments are examples and do not limit the invention. In addition, the embodiments include the modifications of the embodiments defined in the claims.

1. A controller for a robot device including a robot and a three-dimensional vision sensor including a two-dimensional camera configured to capture an image of an object, the controller comprising:
an operation detecting unit configured to detect an operation state of the robot;
an imaging control unit configured to change an exposure condition of the two-dimensional camera;
a position information generating unit configured to generate three-dimensional position information of the object based on a two-dimensional image captured by the two-dimensional camera; and
a synthesis unit configured to implement control for synthesizing a plurality of the two-dimensional images or control for synthesizing a plurality of pieces of the three-dimensional position information, wherein
during a period in which the operation detecting unit detects an operation of the robot, the imaging control unit captures the two-dimensional image at a predetermined interval under a predetermined exposure condition, and
when the operation detecting unit detects stopping of the robot, the imaging control unit changes the exposure condition and captures the plurality of two-dimensional images, and the synthesis unit synthesizes the plurality of two-dimensional images or the plurality of pieces of three-dimensional position information.

2. The controller of claim 1, comprising a manual control unit configured to generate an operation command for manually driving the robot in response to an operation of an operator, wherein
when the operator manually stops the robot, the operation detecting unit detects the stopping of the robot.

3. The controller of claim 1, comprising:
an operation control unit configured to control the operation of the robot; and
a determination unit configured to determine whether or not a defect exists in the two-dimensional image or the three-dimensional position information, wherein
when the determination unit determines that the defect exists in the two-dimensional image or the three-dimensional position information, the operation control unit stops the robot.

4. The controller of claim 1, comprising:
an operation control unit configured to control the operation of the robot;
an automatic control unit configured to generate an operation command for automatically driving the robot according to a predetermined operation program; and
a determination unit configured to determine whether or not a defect exists in the two-dimensional image or the three-dimensional position information, wherein
during a period in which the robot is driven according to the operation command of the automatic control unit, when the determination unit determines that the defect exists in the two-dimensional image or the three-dimensional position information, the operation control unit stops the robot.

5. The controller of claim 1,
wherein
during a period in which the operation detecting unit detects the operation of the robot, the imaging control unit implements control for shortening the exposure time of the two-dimensional camera when a speed at which the robot is driven with respect to an exposure time of the two-dimensional camera exceeds a predetermined determination value.

6. The controller of claim 1,
wherein
the exposure condition is at least one selected from a group of an exposure time of the two-dimensional camera and an amount of light of an illumination device.

7. A robot device comprising:
the controller of claim 1;
a three-dimensional vision sensor including a two-dimensional camera configured to capture an image of an object; and
a robot.

8. The robot device of claim 7, wherein
the three-dimensional vision sensor is attached to the robot, and
the object is an object arranged around the robot.

9. The robot device of claim 7, comprising:
a work tool attached to the robot, wherein
the three-dimensional vision sensor is fixed by a support member at a predetermined position, and
the object is the work tool.
